(19) United States
(12) Patent Application Publication
(10) Pub. No.: US 2005/0184503 A1
(43) Pub. Date: Aug. 25, 2005

(54) Cookbook easel

(75) Inventor: Katherine Scott Reising, Milwaukee, WI (US)

Correspondence Address: WILDMAN HARROLD ALLEN & DIXON, 225 WEST WACKER DRIVE, SUITE 2800, CHICAGO, IL, 60606, US

(73) Assignee: Cookbook Resource USA, Ltd.

(21) Appl. No.: 11/108,297

(22) Filed: Apr. 18, 2005

Related U.S. Application Data
(63) Continuation-in-part of application No. 10/337,682, filed on Jan. 7, 2003.

(51) Int. Cl. B42D 3/00

(52) U.S. Cl. 281/48

(57) ABSTRACT

A cookbook apparatus having a base and a pair of sidewalls capable of being positioned in a generally triangular formation. Each sidewall is connected to opposite sides of the base with a hinge such that the sidewalls and the base form an angle of approximately 55 to 75 degrees with the base in a fully open position. The base is capable of being positioned on a support surface and has a hinge that is parallel to the hinges connecting the sidewalls to the base and permits adjustment of the distance between the sidewalls. A plurality of sheets overlie one another on a surface of one of the sidewalls and food recipe data is positioned on at least one of the sheets. A hinge also connects the top portions of the sidewalls and engages the top portion of the sheets so that the sheets can be moved from overlying one sidewall, about the hinge, to overlie the other sidewall.

### CROSS-REFERENCE TO RELATED APPLICATIONS

This application is a continuation-in-part of prior application Ser. No. 10/337,682, filed Jan. 7, 2003.

### FIELD OF THE INVENTION

This invention relates generally to cookbooks, and more specifically to a cookbook easel that can stand on a surface and display food recipe data.

### SUMMARY OF THE INVENTION

In one embodiment, the present invention relates to a cookbook apparatus having a base and a pair of sidewalls capable of being positioned in a generally triangular formation. Each sidewall is connected to opposite sides of the base with a hinge such that the sidewalls and the base form an angle of approximately 55 to 75 degrees with the base in a fully open position. The base is capable of being positioned on a support surface and has a hinge that is parallel to the hinges connecting the sidewalls to the base and permits adjustment of the distance between the sidewalls. A plurality of sheets overlie one another on a surface of one of the sidewalls and food recipe data is positioned on at least one of the sheets. A hinge also connects the top portions of the sidewalls and engages the top portion of the sheets so that the sheets can be moved from overlying one sidewall, about the hinge, to overlie the other sidewall.

In another embodiment, the present invention relates to a cookbook apparatus having a base and a pair of sidewalls capable of being positioned in a generally triangular formation. Each sidewall is connected to opposite sides of the base with a hinge and one sidewall has a storage pocket connected to the outside surface of the sidewall. The base is capable of being positioned on a support surface and has a hinge that is parallel to the hinges connecting the sidewalls to the base and permits adjustment of the distance between the sidewalls. A plurality of sheets overlie one another on a surface of one of the sidewalls and food recipe data is positioned on at least one of the sheets. A hinge also connects the top portions of the sidewalls and engages the top portion of the sheets so that the sheets can be moved from overlying one sidewall, about the hinge, to overlie the other sidewall.

In another embodiment, the present invention relates to a cookbook apparatus having a base and a pair of sidewalls capable of being positioned in a generally triangular formation. Each sidewall is connected to opposite sides of the base with a hinge and the base is capable of being positioned on a support surface and has a hinge that is parallel to the hinges connecting the sidewalls to the base and permits adjustment of the distance between the sidewalls. A plurality of sheets overlie one another on a surface of one of the sidewalls and food recipe data is positioned only on one side the sheets. A hinge also connects the top portions of the sidewalls and engages the top portion of the sheets so that the sheets can be moved from overlying one sidewall, about the hinge, to overlie the other sidewall.

In another embodiment, the present invention relates to a cookbook apparatus having a base and a pair of sidewalls capable of being positioned in a generally triangular formation. Each sidewall is connected to opposite sides of the base with a hinge and the base is capable of being positioned on a support surface and has a hinge that is parallel to the hinges connecting the sidewalls to the base and permits adjustment of the distance between the sidewalls. A plurality of sheets overlie one another on a surface of one of the sidewalls and an archival area is positioned on one side the sheets. A hinge also connects the top portions of the sidewalls and engages the top portion of the sheets so that the sheets can be moved from overlying one sidewall, about the hinge, to overlie the other sidewall.

In another embodiment, the present invention relates to a cookbook apparatus having a base and a pair of sidewalls capable of being positioned in a generally triangular formation. Each sidewall is connected to opposite sides of the base with a hinge and the base is capable of being positioned on a support surface and has a hinge that is parallel to the hinges connecting the sidewalls to the base and permits adjustment of the distance between the sidewalls. A plurality of sheets overlie one another on a surface of one of the sidewalls and a single recipe is positioned only on one side the sheets. A hinge also connects the top portions of the sidewalls and engages the top portion of the sheets so that the sheets can be moved from overlying one sidewall, about the hinge, to overlie the other sidewall.

In another embodiment, the present invention relates to a cookbook apparatus having a base and a pair of sidewalls constructed of plastic and capable of being positioned in a generally triangular formation. Each sidewall is connected to opposite sides of the base with a hinge and the base is capable of being positioned on a support surface and has a hinge that is parallel to the hinges connecting the sidewalls to the base and permits adjustment of the distance between the sidewalls. A plurality of sheets overlie one another on a surface of one of the sidewalls and food recipe data is positioned on at least one of the sheets. A hinge also connects the top portions of the sidewalls and engages the top portion of the sheets so that the sheets can be moved from overlying one sidewall, about the hinge, to overlie the other sidewall.

### BRIEF DESCRIPTION OF THE DRAWINGS

FIG. 1 is a perspective view of one embodiment of the cookbook easel apparatus of the present invention.

FIG. 2 is a top view of the cookbook easel apparatus of FIG. 1.

FIG. 3 is a bottom view of the cookbook easel apparatus of FIG. 1.

FIG. 4 is a front view of the cookbook easel apparatus of FIG. 1.

FIG. 5 is a side view of the cookbook easel apparatus of FIG. 1.

FIG. 6 is a back view of cookbook easel apparatus of FIG. 1.

FIG. 7 is a side view of the cookbook easel apparatus of FIG. 1 in a closed position.

FIG. 8 is a cross sectional view of the cookbook easel apparatus taken along line 8-8 in FIG. 2.

FIG. 9 is a back view of an exemplary sheet used with the cookbook easel apparatus of FIG. 1.

### DETAILED DESCRIPTION

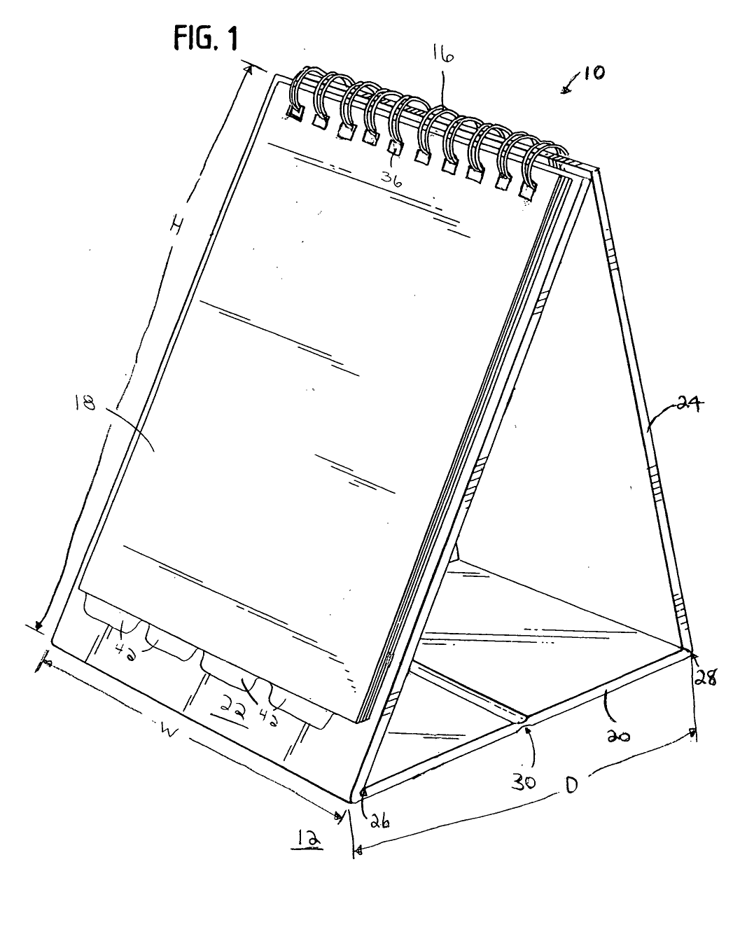

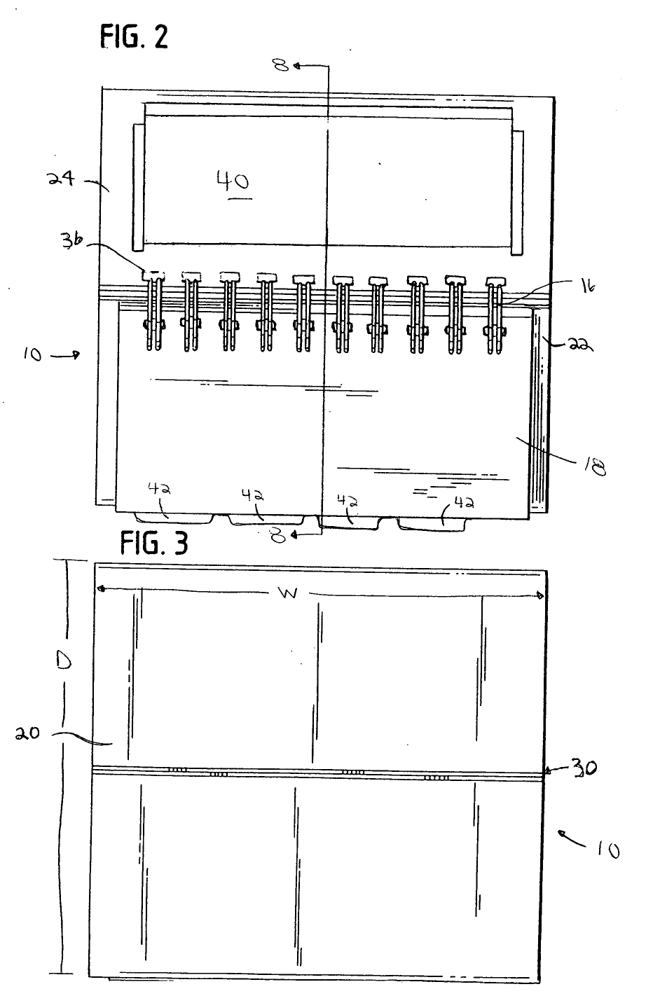

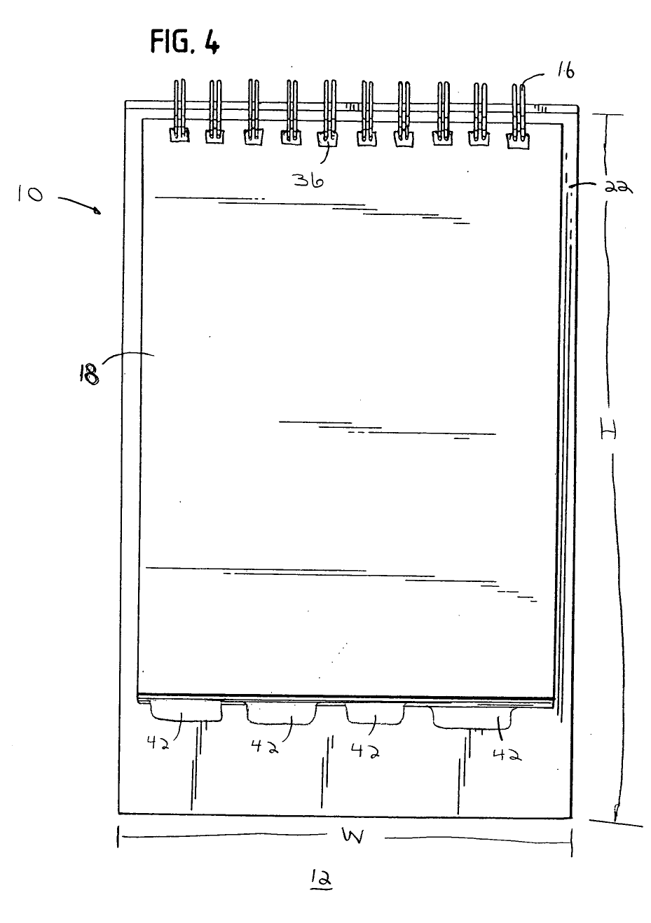

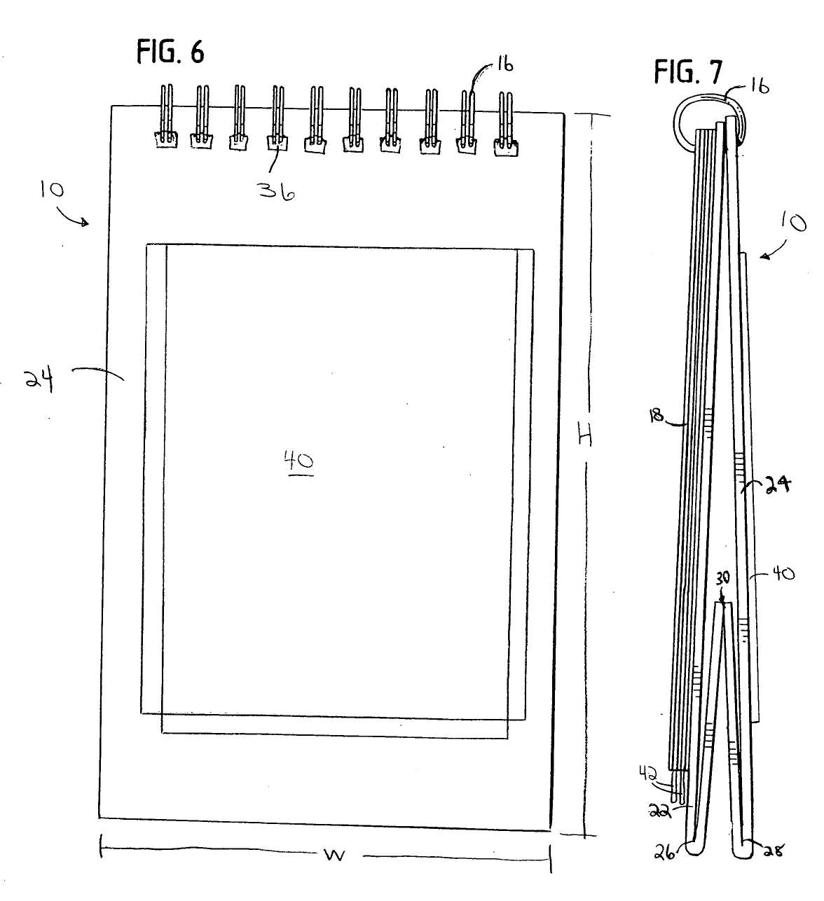

Referring to FIGS. 1-6, a cookbook easel apparatus 10 is capable of being positioned in a generally triangular formation on a support surface 12, such as a kitchen countertop. The cookbook easel generally comprises a base 20, a pair of sidewalls 22, 24, a hinge 16, and one or more overlying sheets 18.

Base 20 is capable of being positioned on support surface 12. Sidewalls 22, 24 are positioned on opposite sides of base 20 and are connected to base 20 by hinges 26, 28. Storage pocket 40 is mounted on the outside surface of sidewall 24 for storage of loose papers, such as recipes or notes, which adds functionality and versatility to the cookbook easel apparatus 10. Although many designs are possible according to the proposed use, storage pocket 40 is generally rectangular and is adhered to the outside surface of sidewall 24. Alternatively, an additional storage pocket could be added on the outside surface of sidewall 22, storage pockets could be mounted on the inside surface of one sidewall or both sidewalls, or no storage pockets need be included at all.

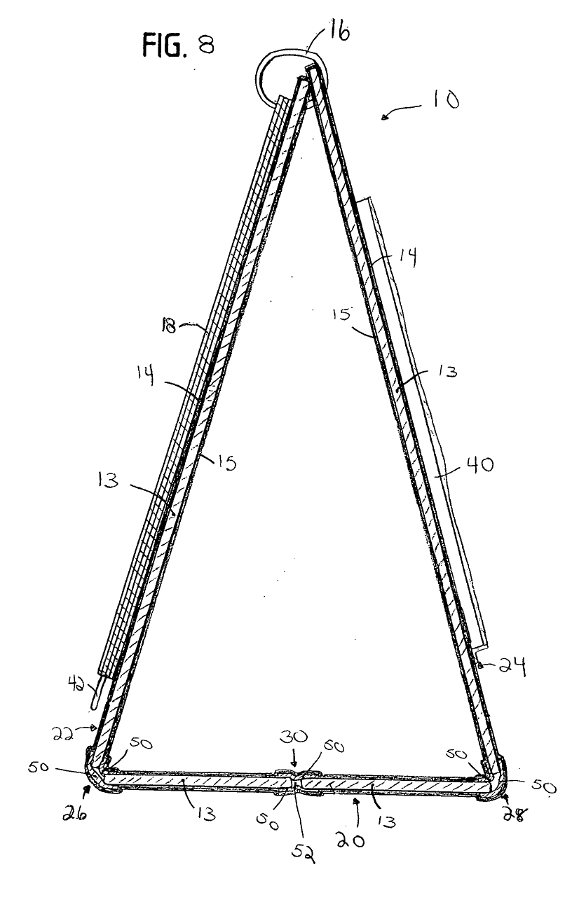

As can be seen in FIG. 8, base 20 and sidewalls 22, 24 are preferably of a paper-over-board construction, which creates a rigid structure for the easel, prevents warping of the base 20 and sidewalls 22, 24, and creates an aesthetically attractive product. Base 20 and sidewalls 22, 24 have a base structure 13 of pasted oak unitized board having a gauge of approximately 80 or 88 point, a cover 14 such as paper or other appropriate covering adhered to the outside surface of the base 20 and sidewalls 22, 24, and a liner 15 or other appropriate covering adhered to the inside surface of the base 20 and sidewalls 22, 24.

Alternatively, the base structure 13 could be any other gauge of pasted oak unitized board or could be another appropriate rigid substrate such as plastic. In addition, depending on the proposed use and desired aesthetics, the paper 14 and liner 15 could also be removed. Another cost-effective alternative is to use cardstock for the construction of the base 20 and sidewalls 22, 24. If cardstock is used, cardstock having a weight of approximately 55 to 60 pounds is preferred.

As can be seen in FIG. 8, hinges 26, 28 are integral to base 20 and sidewalls 22, 24. Hinges 26, 28 are formed by connecting the base structure 13 of the sidewalls 22, 24 to the base structure 13 of the base 20 with reinforcing strips 50, such as cloth tape or another suitable reinforcing material, on each side of the base 20 and sidewalls 22, 24. Alternatively, to produce a more aesthetically pleasing look, the reinforcing strips 50 could be placed only on the inside surfaces of the base 20 and sidewalls 22, 24. The reinforcing strips 50 cover the gap between the base 20 and the sidewalls 22, 24, are covered by the cover 14 and the liner 15, and provide a bendable hinge between the base 20 and sidewalls 22, 24. Alternatively, any other well known method could be used to form the hinges 26, 28 between the base 20 and the sidewalls 22, 24. For example, the reinforcing strips 50 could be removed and the cover 14 and liner 15 could be used to connect the base 20 and the sidewalls 22, 24 and form the hinges 26, 28. If cardstock is used to form the base 20 and sidewalls 22, 24, the hinges 26, 28 could be formed by forming a crease or score where the base 20 meets the sidewalls 22, 24.

Base 20 also includes a hinge 30, which is located between the hinges 26, 28 that connect the base 20 to the sidewalls 22, 24, to allow for the adjustment of the distance between sidewalls 22, 24, as discussed in more detail below, and allow the cookbook easel apparatus 10 to be folded up for storage (see FIG. 7). The hinge 30 is generally parallel to and equidistant between the hinges 26, 28 that connect base 20 to sidewalls 22, 24. Hinge 30 is formed by cutting a slit 52 across the base 20 generally parallel to and equidistant between the hinges 26, 28 that connect base 20 to sidewalls 22, 24, essentially creating two parts to the base 20, and placing reinforcing strips 50 over the slit 52 on each side of the base 20. Alternatively, to produce a more aesthetically pleasing look, a reinforcing strip 50 could be placed only on the inside surface of the base 20. The reinforcing strips 50 cover the slit 52 in the base 20, are covered by the cover 14 and the liner 15, and provide a bendable hinge in the base 20. Alternatively, any other well known method could be used to form the hinge 30 in the base 20. For example, the reinforcing strips 50 could be removed and the cover 14 and liner 15 could be used to cover the slit 52 and form the hinge 30. If cardstock is used to form the base 20, the hinge 30 could be formed by forming a crease or score across the base 20 generally parallel to and equidistant between the hinges 26, 28 that connect base 20 to sidewalls 22, 24.

Referring to FIGS. 1, 4, and 6, the sidewalls 22, 24 preferably have a height “H” of approximately 9 inches and a width “W” of 6 approximately inches, which provides a preferred print area for vertical recipe layout. The dimensions of the sidewalls 22, 24 could be varied depending on the desired use and aesthetics, however a ratio of height to width of approximately 3 to 2 is preferred.

In addition, in certain situations, such as cookbook easels using large print for the visually handicapped, the ratio of height to width of the sidewalls 22, 24 could be approximately 1 to 1. If a ration of 1 to 1 is used, the sidewalls 22, 24 would preferably have a height “H” and width “W” of approximately 8½ inches.

Referring to FIGS. 1, 3, and 5, the base 20 preferably has a width “W” that is the same as the width of the sidewalls 22, 24, or approximately 6 inches, and a depth “D” of approximately 7 1,2 inches. Alternatively, if sidewalls 22, 24 having a width of approximately 8½ inches are used, the width of the base 20 would be approximately 8½ inches and the depth would be adjusted to approximately 7 inches to provide an optimal viewing angle, as described in more detail below.

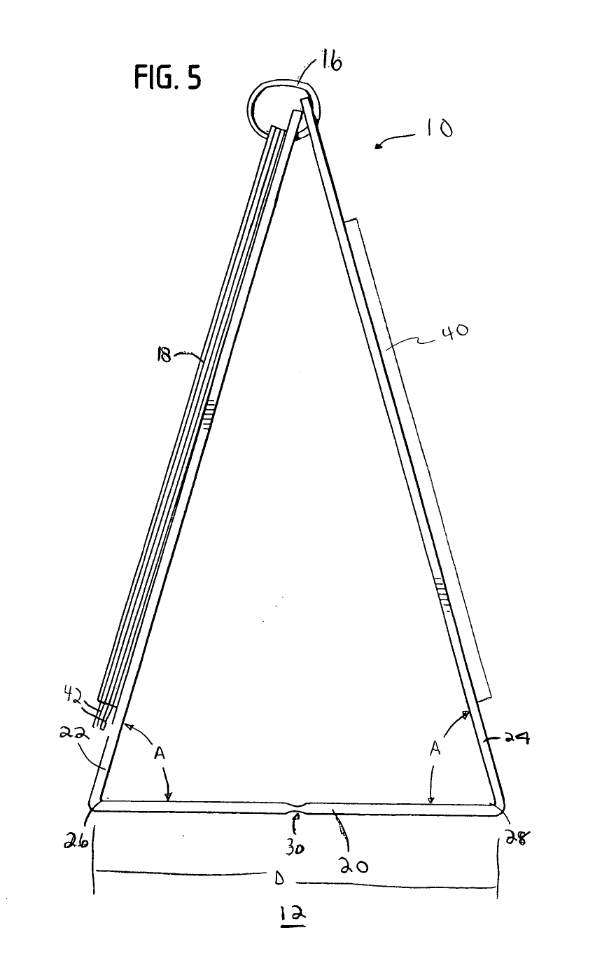

As can best be seen in FIG. 5, the angle “A” formed between base 20 and sidewalls 22, 24 with the base 20 fully extended is preferably approximately 65 degrees, which provides the optimal viewing angle for reading when the cookbook easel apparatus 10 is placed on a support surface 12, such as a countertop. This angle is automatically formed if the preferred sidewall 22, 24 height of 9 inches and base 20 depth of 7½ inches is used, or if other heights and widths having the same ratio are used. Although an angle of 65 degrees is preferred, the angle could be between 55 and 75 degrees and the viewing angle would still be acceptable. An angle too much less than 55 degrees creates bowing of sidewalls 22, 24 under the weight of the plurality of sheets 18.

The angle “A” formed between the base 20 and the sidewalls 22, 24, and therefore also the viewing angle of the cookbook easel apparatus 10, can also be varied by manipulating hinge 30 in base 20. If hinge 30 is raised, the distance between hinges 26, 28 decreases and a more acute angle is formed between the base 20 and sidewalls 22, 24. This in turn changes the viewing angle and allows the cookbook easel apparatus 10 to be adjusted to the optimal viewing angle for a given user. This feature is useful because it enables a user to vary the angle of the food recipe data display according to his/her viewing preferences. As a result, the user is able to refer to the food recipe data easily. This is also useful because when the distance between the hinges 26, 28 is decreased, a user can operate the cookbook easel apparatus 10 using only a small amount of surface area. If the hinge 30 is fully raised, it allows the cookbook easel apparatus 10 to easily collapse and be stored (see FIG. 7).

Sheets 18 are positioned to overlie another on the outside surface of the sidewalls 22, 24, which allows for easy reading of information on the sheets 18. The sheets 18 are preferably constructed of paper having a weight of approximately 70 to 80 pounds but could also be constructed of cardstock having a weight of approximately 55 to 65 pounds or any other suitable sheet material. When cardstock is used for sidewalls 22, 24 and base 20 as well as for sheets 18, the same cardstock, having a weight between approximately 55 to 65 pounds, should be used for both the sidewalls 22, 24, base 20, and sheets 18.

Sheets 18 preferably have food recipe data, comprising a single recipe, printed on only one side of each sheet 18. This creates a reading sequence that flows recipe data text across sheet fronts only, which creates a simple, efficient reading sequence. The reader flips sheets 18 front to back over the hinge 16 to read the recipe data. There is no need to rotate the cookbook easel apparatus 10 to read recipe data on the backside of the sheets 18.

In addition to sheets 18 that have preprinted recipes, sheets 18 could also be provided that are blank and allow for recording personal recipes. This adds versatility to the cookbook easel apparatus 10. Alternatively, all of the sheets 18 could be blank and dedicated to recording personal recipes using blank recipe templates.

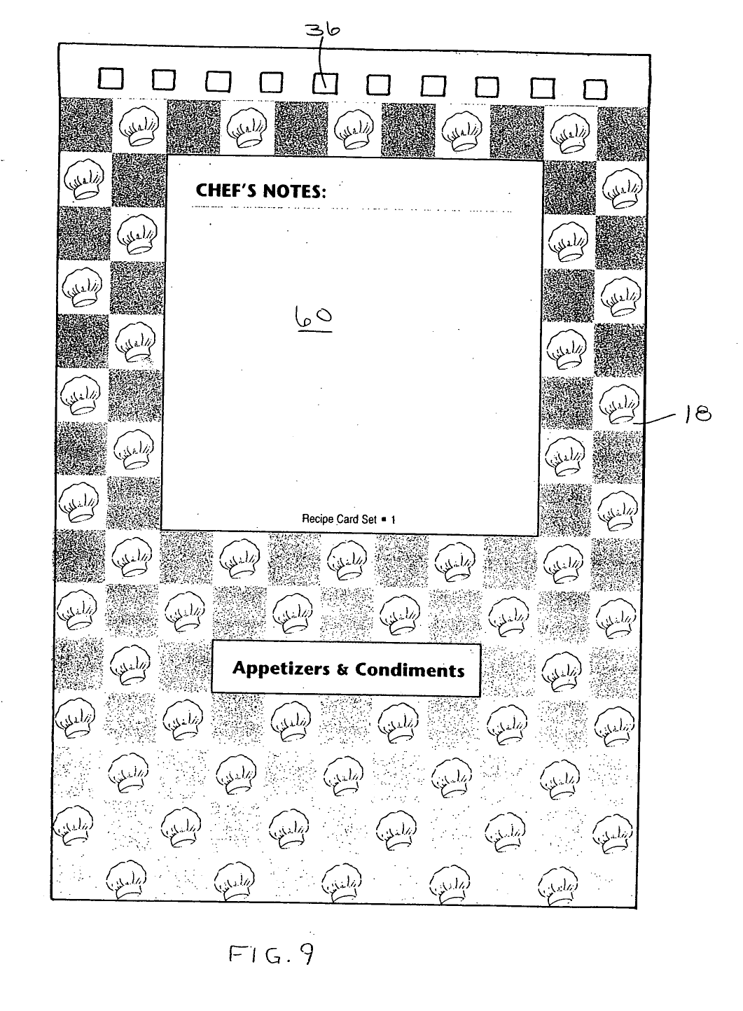

As can been seen in FIG. 9, the second or back side of each sheet 18, opposite the food recipe data, contains an archival area 60, that can be used to record notes and miscellaneous information and can be any size desired. For example, the entire back side of each sheet 18 could be left blank as the archival area 60, or a defined archival area 60 could be provided and additional text and/or graphics could be added, such as key headline tag words such as “notes” or a possible art border.

Divider pages are dispersed between the sheets 18 to provide division of the sheets 18 into desirable sections and have index tabs 42 extending therefrom. For example, the divider sheets could be used to separate recipes for main course meals from appetizers from desserts, etc. and the index tabs 42 provide a quick and easy method for turning directly to these recipes. The divider pages and index tabs 42 are preferably constructed of cardstock to provide rigidity and the index tabs 42 could extend from the side and/or bottom of the divider pages as desired. The divider pages have holes 36 formed in the top portion of the divider sheets through which the hinge 16 passes, as discussed in more detail below. Alternatively, divider pages without index tabs could also be used or if divider pages are not desired, the divider pages can be removed.

As can be seen in FIGS. 1, 2, and 4, the sidewalls 22, 24 preferably have a height “H” and a width “W” that are larger than the height and width of the sheets 18. This protects the edges of the sheets 18 from damage due to vertical and/or horizontal shifting of the sheets 18, which typically will sag when hanging from the hinge 16. If sidewalls 22, 24 are constructed of cardstock, the sidewalls 22, 24 can have the same height and width as the sheets 18 since slippage of the sheets 18 is negligible. However, due to cardstock's lack of rigidity, only small cookbook easel apparatus 10 are practical.

Referring to FIGS. 1, 2, 4, 6, and 9, the sidewalls 22, 24 and the sheets 18 each have holes 36 formed near the top thereof for receiving the hinge 16. Preferably, the holes 36 are rectangular or square to provide optimal structural integrity and tear protection to the sidewalls 22, 24 and sheets 18, however, holes 36 could also be circular, oval, or any other shape desired.

Hinge 16 passes through holes 36 to connect the sidewall 22, 24 and to fasten sheets 18 and the divider pages. Preferably, hinge 16 is a wiro binding, however, other materials/bindings can also be used to connect sidewalls 22, 24, including but not limited to, spiral binding, clips, or perforated binding elements. Alternatively, hinge 16 could also be capable of opening and closing, so that one or more sheets 18 or divider pages could be added or removed. The diameter of the spiral binding will vary depending on the stock used for the sheets (i.e. the heavier the stock the larger the diameter of the binding) and the number of sheets 18 and divider pages (i.e. the more sheets the larger the diameter of the binding).

The foregoing description of the preferred embodiments of the invention have been presented for purposes of illustration and description, and are not intended to be exhaustive or to limit the invention to the precise forms disclosed. The descriptions were selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

1. A cookbook apparatus, comprising:
a base and a pair of sidewalls capable of being positioned in generally a triangular formation;
the sidewalls positioned on opposing sides of the base, each sidewall connected to the base with a hinge such that the angle formed between each sidewall and the base is between approximately 55 and 75 degrees with the base in a fully open position;
the base capable of being positioned on a support surface and having a third hinge positioned generally parallel to the hinges connecting the sidewalls and the base and permitting adjustment of a distance between the hinges connecting the sidewalls and the base;
a plurality of sheets positioned to overlie one another on a surface of at least one of the sidewalls in which food recipe data is positioned on at least one of the sheets; and
a fourth hinge connecting a top portion of each of the sidewalls and engaging a top portion of the plurality of sheets permitting at least one of the sheets to be moved from an overlying position of one of the sidewalls and about the fourth hinge to an overlying position of the other sidewall.

2. A cookbook apparatus, as recited in claim 1, wherein that the angle formed between each sidewall and the base is approximately 65 degrees with the base in a fully open position.

3. A cookbook apparatus, as recited in claim 1, wherein each sidewall has a height of approximately 9 inches and the base has a depth of approximately 7½ inches.

4. A cookbook apparatus, as recited in claim 3, wherein each sidewall has a width of approximately 6 inches.

5. A cookbook apparatus, as recited in claim 1, wherein each sidewall has a height of approximately 8 1,2 inches and the base has a depth of approximately 7 inches.

6. A cookbook apparatus, as recited in claim 5, wherein each sidewall has a width of approximately 8½ inches.

7. A cookbook apparatus, comprising:
a base and a pair of sidewalls capable of being positioned in generally a triangular formation;
the sidewalls positioned on opposing sides of the base, each sidewall connected to the base with a hinge;
the base capable of being positioned on a support surface and having a third hinge positioned generally parallel to the hinges connecting the sidewalls and the base and permitting adjustment of a distance between the hinges connecting the sidewalls and the base;
a plurality of sheets positioned to overlie one another on a outside surface of at least one of the sidewalls in which food recipe data is positioned on at least one of the sheets;
a fourth hinge connecting a top portion of each of the sidewalls and engaging a top portion of the plurality of sheets permitting at least one of the sheets to be moved from an overlying position of one of the sidewalls and about the fourth hinge to an overlying position of the other sidewall; and
a storage pocket connected to an outside surface of at least one of the sidewalls.

8. A cookbook apparatus, as recited in claim 7, further comprising a second storage pocket connected to an outside surface of the other sidewall.

9. A cookbook apparatus, comprising:
a base and a pair of sidewalls capable of being positioned in generally a triangular formation;
the sidewalls positioned on opposing sides of the base, each sidewall connected to the base with a hinge;
the base capable of being positioned on a support surface and having a third hinge positioned generally parallel to the hinges connecting the sidewalls and the base and permitting adjustment of a distance between the hinges connecting the sidewalls and the base;
a plurality of sheets positioned to overlie one another on a outside surface of at least one of the sidewalls, each of the plurality of sheets having a first side and a second side, in which food recipe data is positioned on only the first side of the sheets;
a fourth hinge connecting a top portion of each of the sidewalls and engaging a top portion of the plurality of sheets permitting at least one of the sheets to be moved from an overlying position of one of the sidewalls and about the fourth hinge to an overlying position of the other sidewall.

10. A cookbook apparatus, comprising:
a base and a pair of sidewalls capable of being positioned in generally a triangular formation;
the sidewalls positioned on opposing sides of the base, each sidewall connected to the base with a hinge;
the base capable of being positioned on a support surface and having a third hinge positioned generally parallel to the hinges connecting the sidewalls and the base and permitting adjustment of a distance between the hinges connecting the sidewalls and the base;
a plurality of sheets positioned to overlie one another on a outside surface of at least one of the sidewalls, each of the plurality of sheets having a first side and a second side, in which an archival area is positioned on the second side of the sheets;
a fourth hinge connecting a top portion of each of the sidewalls and engaging a top portion of the plurality of sheets permitting at least one of the sheets to be moved from an overlying position of one of the sidewalls and about the fourth hinge to an overlying position of the other sidewall.

11. A cookbook apparatus, comprising:
a base and a pair of sidewalls capable of being positioned in generally a triangular formation;
the sidewalls positioned on opposing sides of the base, each sidewall connected to the base with a hinge;
the base capable of being positioned on a support surface and having a third hinge positioned generally parallel to the hinges connecting the sidewalls and the base and permitting adjustment of a distance between the hinges connecting the sidewalls and the base;
a plurality of sheets positioned to overlie one another on a outside surface of at least one of the sidewalls, each of the plurality of sheets having a first side and a second side, in which a single recipe is positioned on only the first side of the sheets;
a fourth hinge connecting a top portion of each of the sidewalls and engaging a top portion of the plurality of sheets permitting at least one of the sheets to be moved from an overlying position of one of the sidewalls and about the fourth hinge to an overlying position of the other sidewall.

12. A cookbook apparatus, comprising:
a base and a pair of sidewalls capable of being positioned in generally a triangular formation, the base and sidewalls being constructed of plastic;
the sidewalls positioned on opposing sides of the base, each sidewall connected to the base with a hinge;
the base capable of being positioned on a support surface and having a third hinge positioned generally parallel to the hinges connecting the sidewalls and the base and permitting adjustment of a distance between the hinges connecting the sidewalls and the base;
a plurality of sheets positioned to overlie one another on a outside surface of at least one of the sidewalls in which food recipe data is positioned on at least one of the sheets;
a fourth hinge connecting a top portion of each of the sidewalls and engaging a top portion of the plurality of sheets permitting at least one of the sheets to be moved from an overlying position of one of the sidewalls and about the fourth hinge to an overlying position of the other sidewall.

13. A cookbook apparatus, as recited in claims 1, 7, 9, 10, 11, or 12, further comprising at least one divider sheet, disposed between the plurality of sheets, the divider sheet having an index tab extending therefrom.

14. A cookbook apparatus, as recited in claims 1, 7, 9, 10, 11, or 12, wherein the sheets are constructed of paper having a weight of approximately 70 to 80 pounds.

15. A cookbook apparatus, as recited in claims 1, 7, 9, 10, 11, or 12, wherein the sheets are constructed of cardstock having a weight of approximately 55 to 65 pounds.

16. A cookbook apparatus, as recited in claims 1, 7, 9, 10, 11, or 12, further comprising a plurality of square holes formed in the top portion of the plurality of sheets such that the fourth hinge engages the plurality of square holes.

17. A cookbook apparatus, as recited in claims 1, 7, 9, 10, 11, or 12, wherein the third hinge comprises:
a slit formed across the width of the base;
a reinforcement strip disposed adjacent to the slit; and
paper secured to the base disposed over the slit and the reinforcement strip.

18. A cookbook apparatus, as recited in claims 1, 7, 9, 10, 11, or 12, wherein each of the hinges that connect the base and the sidewalls comprise:
a slit formed across the width of the base where the base meets each sidewall;
a reinforcement strip disposed adjacent to each slit; and
paper secured to the base and sidewalls and disposed over the slits and the reinforcement strips.

19. A cookbook apparatus, as recited in claims 1, 7, 9, 10, 11, or 12, wherein each of the sidewalls forms an acute angle with the base and are adjustable such that if the third hinge in the base is raised a more acute angle is formed between the side walls and sections of the base to adjust the angle of the sidewalls to obtain an optimal viewing angle.

20. A cookbook apparatus, as recited in claims 1, 7, 9, 10, 11, or 12, wherein:
the base and sidewalls are constructed of approximately 80 point pasted oak unitized board;
paper is secured to the base and sidewalls on one side of the base and sidewalls;
and
a liner is secured to the base and sidewalls on a second side of the base and sidewalls, opposite the paper.

21. A cookbook apparatus, as recited in claims 1, 7, 9, 10, 1 1, or 12, wherein:
the base, sidewalls, and plurality of sheets are constructed of cardstock having a weight between approximately 55 to 65 pounds; and
the sidewalls and plurality of sheets have approximately the same height and width.

22. A cookbook apparatus, as recited in claims 1, 7, 9, 10, 11, or 12, wherein the hinges connecting the sidewalls to the base are integral with the base and the sidewalls.

23. A cookbook apparatus, as recited in claims 1, 7, 9, 10, 11, or 12, wherein the third hinge is positioned generally equal distance from each of the hinges connecting the opposing sidewalls to the base.
